(19) United States
(12) Patent Application Publication
(10) Pub. No.: US 2026/0196203 A1
(43) Pub. Date: Jul. 9, 2026

(54) SCORE-DISTILLATION SAMPLING FOR GENERATING AUDIO USING GENERATIVE ARTIFICIAL INTELLIGENCE

(71) Applicant: NVIDIA Corporation, Santa Clara, CA (US)

(72) Inventors: Jonathan Lorraine, Toronto (CA); Jessie Richter-Powell, Toronto (CA); Sanja Fidler, Toronto (CA)

(73) Assignee: NVIDIA Corporation, Santa Clara, CA (US)

(21) Appl. No.: 19/011,251

(22) Filed: Jan. 6, 2025

(51) Int. Cl. G10K 15/02; H04S 7/00

(52) U.S. Cl. CPC G10K 15/02; H04S 7/302

(57) ABSTRACT

In various examples, systems and methods are disclosed relating to using score-distillation sampling to generate sound. A system can generate an initial audio sample according to an initial set of parameters. The system can apply noise to the initial audio sample to generate a noised audio sample. The system can generate predicted noise using a diffusion model, the noised audio sample, and an input prompt. The system can update the initial set of parameters according to the predicted noise and the noise to generate a set of updated parameters.

### BACKGROUND

Generative artificial intelligence models can be trained/updated using supervised learning techniques to generate sound for a variety of contexts. Such approaches typically require a corpus of known sound data from the domain that the generative artificial intelligence model is targeting. It is challenging to effectively train/update generalized generative artificial intelligence models to generate sound for domains where large corpuses of sound data are not available.

### SUMMARY

Machine-learning techniques used to generate audio data typically rely on large generative machine-learning models that are trained/updated on extensive corpuses of audio data. Such approaches often involve training/updating text-to-audio diffusion models to generate output audio data based on input text prompts. However, these methods are limited in their ability to derive properties or parameters associated with the generated audio data across different, simulated contexts. For instance, while these models can generate audio samples, they cannot produce parameters that can be used to generate audio samples in various simulated environments.

The techniques described herein address these limitations by implementing score distillation sampling to sample plausible parameters for generating target audio data. Specifically, a set of initial parameters can be used to generate initial audio data, to which noise, such as Gaussian noise, can be added. The noised audio can then be provided as input to a pretrained audio diffusion model, along with text input (e.g., natural language text input) specifying target properties for the audio data. The audio diffusion model can predict denoised audio data that aligns with the specified target properties. This predicted denoised audio data can be used to infer the noise content of the rendered audio sample, which in turn is utilized to determine an updated set of parameters. In some implementations, the updated parameters may be generated using a vector Jacobian product (VJP). This process can be iteratively repeated until a stopping criterion is met, thereby enabling the generation of audio data parameters that can be used in various simulated contexts without the need for direct training or updating of task-specific generative machine-learning models.

At least one aspect relates to one or more processors. The one or more processors can include one or more circuits. The one or more circuits can generate an initial audio sample according to an initial set of parameters (e.g., to be optimized using score-distillation sampling (“SDS”)). The one or more circuits can apply noise to the initial audio sample to generate a noised audio sample. The one or more circuits can generate predicted noise using a diffusion model, the noised audio sample, and an input prompt (e.g., specifying characteristics of parameters to be optimized, such as material properties, proximity/distance for spatial audio, etc.). The one or more circuits can update the initial set of parameters (e.g., using gradient descent/optimizer) according to the predicted noise and the noise to generate a set of updated parameters (e.g., for next iteration).

In some implementations, the input prompt identifies at least one material property (e.g., of materials for colliding objects), and the one or more circuits can generate the initial audio sample using a physical simulation according to the initial set of parameters. In some implementations, the input prompt identifies a relative location of a sound source, and the one or more circuits can simulate spatial audio according to the initial set of parameters to generate the initial audio sample. In some implementations, the one or more circuits can update the initial set of parameters based at least on a VJP.

In some implementations, the one or more circuits can update the initial set of parameters according to a gradient descent function (e.g., to optimize the parameters). In some implementations, the one or more circuits can determine a loss based at least on the predicted noise and the noise and update the initial set of parameters to minimize the loss using the gradient descent function. In some implementations, the one or more circuits can iteratively update the updated set of parameters (e.g., repeat SDS optimization) until a termination criterion is satisfied. In some implementations, the termination criterion comprises a predetermined number of iterations. In some implementations, the one or more circuits can generate the noise according to a Gaussian distribution (e.g., add Gaussian noise to the audio sample).

At least one aspect relates to a system. The system can include one or more processors. The system can iteratively update a set of parameters by rendering an audio sample using the set of parameters, applying noise to the audio sample, and applying gradient descent optimization to the set of parameters according to an output of an audio diffusion model and the noised audio sample. The system can determine that a termination criterion for updating the set of parameters has been satisfied. Responsive to determining that the termination criterion is met, the system can provide an output audio sample generated using the updated set of parameters.

In some implementations, the system can generate the output of the audio diffusion model further based on an input text prompt specifying a target attribute of the audio sample. In some implementations, the system can calculate a gradient for updating the parameters using the output of the audio diffusion model and the noise applied to the audio sample. In some implementations, the system can initialize the set of parameters to random values. In some implementations, the system can optimize a plurality of sets of parameters to generate a plurality of audio samples, at least one audio sample corresponding to one or more respective target attributes.

At least one aspect is related to a method. The method can include generating, using one or more processors, an initial audio sample according to an initial set of parameters. The method can include applying, using one or more processors, noise to the initial audio sample to generate a noised audio sample. The method can include generating, using one or more processors, predicted noise using a diffusion model, the noised audio sample, and an input prompt. The method can include updating, using one or more processors, the initial set of parameters according to the predicted noise and the noised audio sample to generate a set of updated parameters. The method can include generating an output audio sample according to the set of updated parameters. The method can include storing the output audio sample in a dataset of audio samples.

In some implementations, the input prompt identifies at least one material property, and the method can further include generating, using one or more processors, the initial audio sample using a physical simulation according to the initial set of parameters. In some implementations, the input prompt identifies a relative location of a sound source, and the method can further include simulating, using one or more processors, spatial audio according to the initial set of parameters to generate the initial audio sample. In some implementations, the method can further include updating, using one or more processors, the initial set of parameters based at least on a VJP.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a video language model, a system implemented using an edge device, a system implemented using a robot, a system for performing conversational AI operations, a system for generating synthetic data, a system incorporating one or more virtual machines (VMs), a system using or deploying one or more inference microservices, a system that incorporates one or more machine learning models deployed in a service or microservice along with an operating system (OS)-level virtualization package (e.g., a container), a system implemented at least partially in a data center, or a system implemented at least partially using cloud computing resources.

### BRIEF DESCRIPTION OF THE DRAWINGS

The present systems and methods for using score-distillation sampling to generate audio are described in detail below with reference to the attached drawing figures, wherein:

FIG. 1 is a block diagram of an example system for using score-distillation sampling to generate audio, in accordance with some embodiments of the present disclosure;

FIG. 2 depicts an example data flow diagram showing the iterative optimization of parameters for rendering audio according to the score-distillation sampling techniques described herein, in accordance with some embodiments of the present disclosure;

FIG. 3 is a flow diagram of an example of a method for using score-distillation sampling to generate audio, in accordance with some embodiments of the present disclosure;

FIG. 4 is a block diagram of an example computing device suitable for use in implementing at least some embodiments of the present disclosure; and

FIG. 5 is a block diagram of an example data center suitable for use in implementing at least some embodiments of the present disclosure.

### DETAILED DESCRIPTION

This disclosure relates to systems and methods for implementing score distillation sampling for generating audio data, for example, for different objects having different materials. Score distillation sampling is a technique used to generate new or data samples, which may be useful for contexts in which real-world examples are limited in number. Score distillation sampling is implemented by sampling parameters to generate samples while iteratively minimizing a loss that measures the discrepancy between features of a generated sample and features of a target distribution.

Score distillation sampling has been implemented to generate output synthetic datasets without directly training/updating a generative machine-learning model to produce the synthetic datasets. One conventional application of score distillation sampling is used to implement text-to-three-dimensional (3D) model synthesis using a pre-trained two-dimensional (2D) text-to-image diffusion model. This approach optimizes a randomly initialized 3D model such that its 2D renderings align with predicted 2D images produced using the text-to-image diffusion model. However, these approaches have been limited to the generation of 3D images and cannot be applied to other media modalities such as audio.

Traditional approaches for generating audio data typically rely on using large generative models that are trained/updated on large corpuses of audio and corresponding text data. Such approaches may include training/updating and/or executing text-to-audio diffusion models to generate output audio data according to input text prompts. However, such approaches cannot be used to derive properties or parameters associated with this sound data across other, simulated contexts. Such approaches, while capable of generating output sound data, cannot be used to generate parameters that themselves can be used to generate audio samples using an audio rendering function.

To address these deficiencies, the techniques described herein implement score distillation sampling to sample plausible parameters to generate target audio by leveraging the output of a pretrained audio diffusion model. To sample parameters for audio using score distillation sampling, a set of initial parameters can be used to generate/render initial audio data. Noise, such as Gaussian noise, can be added to the initial audio data, and the resulting noised audio can be provided as input to a pretrained audio diffusion model with text input specifying target properties for the audio data.

The audio diffusion model can predict denoised audio data that resembles the target properties specified via the text input. The predicted denoised audio data can then be used to predict the noise content of the rendered/generated audio sample, for example, using a combination of the noised audio sample and the predicted denoised audio. The noise content of the audio data can be used to determine an updated set of parameters. In some implementations, the updated parameters may be generated using a vector Jacobian product (VJP). Updated parameters can be used to generate/render audio data for a subsequent iteration. This process can be iteratively repeated until a stopping/termination criterion is met.

Any suitable parameters for generating/rendering/simulating audio data can be determined according to these techniques. In some implementations, the parameters can include material properties for colliding materials depicted in video or 3D physical simulations. In another example, parameters such as distance or intensity can be determined for generating/rendering/simulating spatial audio in simulated 3D environments. Such approaches can be used to accurately model different types of audio information without directly training/updating task-specific generative machine-learning models.

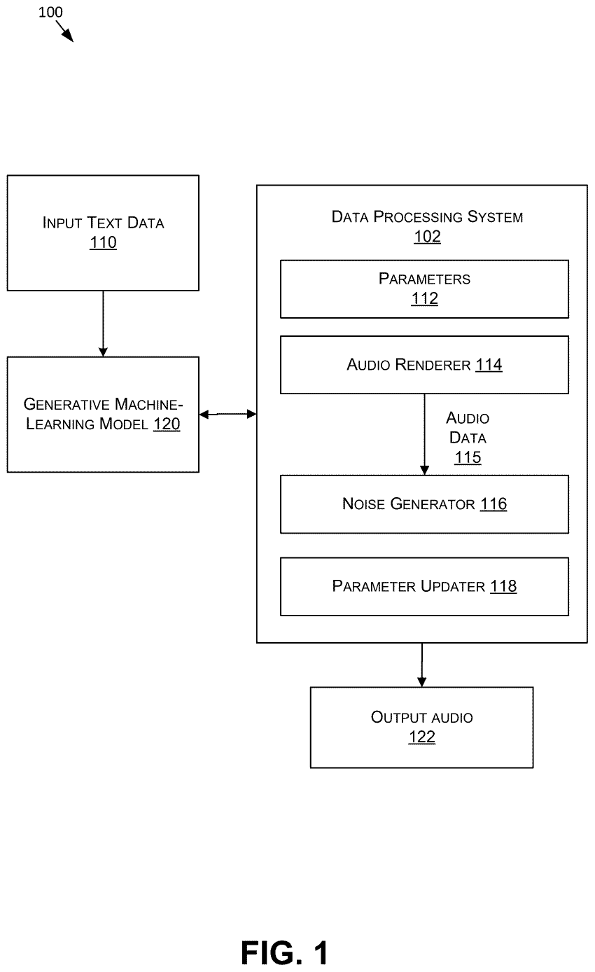

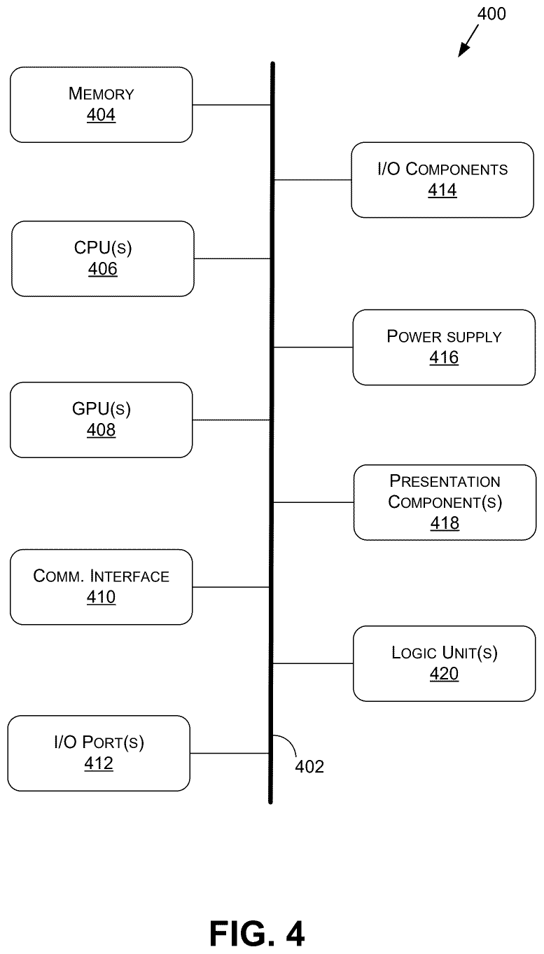

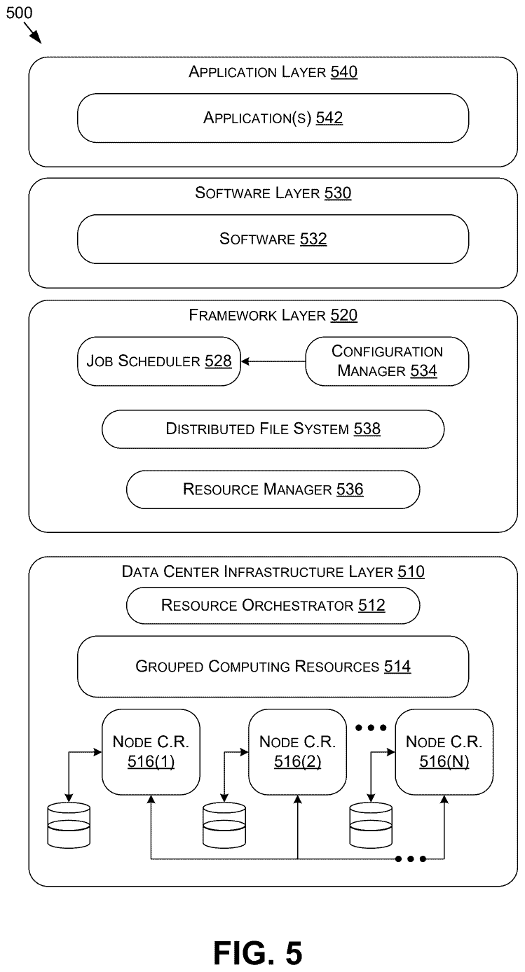

With reference to FIG. 1, FIG. 1 is an example computing environment including a system 100 for using score-distillation sampling to generate audio, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more computing devices or components thereof (e.g., as described in FIG. 4), and/or one or more data centers or components thereof (e.g., as described in FIG. 5).

The system 100 can be used to implement score-distillation sampling to generating audio without requiring training/update processes for task-specific generative machine-learning models. The system is shown as including a data processing system 102, input text data 110, a generative machine-learning model 120, and output audio 122. The data processing system 102 is shown as including a set of parameters 112, an audio renderer 114 that can generate audio data 115, a noise generator 116, and a parameter updater 118. As described in further detail herein, the data processing system 102 can implement score-distillation sampling to optimize the set of parameters according to output from a generative machine-learning model 120. The data processing system 102 can execute the audio renderer 114 to generate audio data 115 using the set of parameters 112. The noise generator 116 can add noise to the generated audio data 115 and provide the resulting noised audio data as input to the generative machine-learning model 120. The parameter updater 118 can optimize the parameters 112 for the audio renderer 114 using the output of the generative machine-learning model 120 and the noised audio data.

The data processing system 102 can include one or more processors, circuits, memory, and/or computing devices/systems that can perform the various techniques described herein. The data processing system 102 can be implemented, for example, in a cloud computing environment, which may maintain, update, and/or execute one or more generative machine-learning models 120. The data processing system 102 can implement the various techniques described herein to automatically optimize parameters 112 for different audio renderers 114 and according to different configurations (e.g., specified in the input text data 110, etc.). The optimization process implemented by the data processing system 102 can be initiated in response to a request from an external computing system (e.g., a client device) in communication with the data processing system 102 and/or in response to operator input at the data processing system 102.

The data processing system 102 can optimize a set of parameters 112, which may be or include parameters 112 for an audio generation process, such as a physical simulation or any other differentiable sound rendering process. Differentiable sound rendering processes can include techniques that model sound propagation and perception in a way that allows gradients to be computed with respect to provided parameters 112. Example parameters 112 may include values representing material properties, geometry, or sound source characteristics, among others. The parameters 112 can be stored in any suitable data structure, including but not limited to vectors, matrices, or tensors, among others. The parameters 112 may be stored in memory of the data processing system 102 and accessed to perform the various optimization techniques described herein.

In one example, the parameters 112 can include parameters for computational models that enable the generation of audio data 115 by simulating physical phenomena in a manner that is differentiable with respect to the input parameters 112. For example, these processes can simulate the interaction of sound waves with various materials and environments, allowing for the generation of realistic samples of audio data 115 that conform to the provided parameters 112. Furthering this example, the parameters 112 can include material properties such as density, elasticity, and damping coefficients, as well as environmental properties like room acoustics and parameters for simulating spatial audio such as spatial configurations.

When performing the techniques described herein, the data processing system 102 can generate a set of parameters to optimize for a given target audio output. The target audio output may be specified, in one example, via the input text data 110 in a natural language format, as described in further detail herein. In some implementations, the data processing system 102 can initiate the process for optimizing a set of parameters 112 to generate output audio 122 in response to receiving input text data 110 and/or a request that includes input text data 110. The data processing system 102 can initialize a set of parameters 112 for the score-distillation sampling process. Initializing the parameters may include allocating a region of memory to store the parameters 112 for the parameter 112 optimization techniques described herein. The amount of memory allocated for the parameters may be a function of the type of differentiable audio rendering performed via the audio renderer 114.

In some implementations, the parameters 112, once generated/allocated, can be initialized based on a set of default values. The default values may correspond to the type of audio rendering performed by the audio renderer 114. Furthering the example above, in some implementations, the parameters 112 can be initialized with values that represent typical material properties or environmental conditions. In some implementations, the parameters 112 can be initialized randomly, with each element of the data structure assigned a value within a predefined range. In some implementations, the parameters 112 may be automatically initialized to values used in a prior/similar audio rendering task, which may result in the initial parameters 112 being closer to an optimal value than a randomly initialized set of parameters 112.

The data processing system 102 can iteratively update the set of parameters according to the score-distillation sampling techniques described herein. In the first iteration, after initializing the set of parameters 112, the data processing system can execute an audio renderer 114 to render a sample of audio data 115 using the set of parameters 112. The audio renderer 114 can include software, hardware, or combinations of hardware and software. To render a sample of audio data 115, the audio renderer 114 can implement a differentiable sound rendering process using the set of parameters 112. Any suitable differentiable sound rendering process may be implemented by the audio renderer 114, including but not limited to physical simulations (e.g., where the parameters 112 can be material and/or environmental properties/attributes), wave-based approaches that solve partial differential equations to simulate propagation of sound waves, ray-based approaches that simulate “rays” of sound particles propagating through an environment according to the parameters, and/or neural network-based audio generators that receive at least parameters 112 as input, among others.

In some implementations, the audio rendering process executed by the audio renderer 114 can involve simulating the propagation and interaction of sound waves with various materials and environments, allowing for the generation of realistic audio samples that conform to the provided parameters 112. For example, the audio renderer 114 can simulate the interaction of sound waves with materials such as wood, metal, or glass, among others, each with distinct acoustic properties. In such implementations, the parameters 112 may include material properties such as density, elasticity, and damping coefficients, which influence the sound wave propagation and reflection characteristics. In some implementations, the audio renderer 114 can simulate environmental conditions, such as room acoustics and spatial configurations, which may use example parameters that represent the geometry and material composition of the environment. In some implementations, the audio renderer 114 can simulate spatial audio, which may include simulated audio that appears to originate from a sound source positioned relative to the user in three-dimensional space.

The audio renderer 114 can execute the audio rendering process using the set of parameters to generate a sample of audio data 115. In some implementations, the audio data 115 generated by the audio renderer 114 can be provided in various formats, such as raw waveform audio (WAV) format audio or an encoded format such as MPEG Audio Layer 3 (MP3) or free lossless audio codec (FLAC). The audio data 115 can be generated and/or encoded into a format compatible with the generative machine-learning model 120. For example, the audio data 115 can be generated, encoded, or otherwise formatted such that the audio data 115 conforms to one or more input layers of the generative machine-learning model 120. The audio data 115 can be sampled at different rates and bit depths, which may be specified via configuration settings of the data processing system 102, via a request received from an external computing system, and/or via operator input to the data processing system 102.

During the initial iterations of the parameter optimization process, the sample of audio data 115 generated by the audio renderer 114 may not accurately reflect the target attributes specified via the input text data 110. For example, the initial audio data 115 might not match the desired characteristics, such as the material properties or environmental conditions specified in the input text data 110. This discrepancy arises because the initial set of parameters 112 may not be finely tuned to produce audio data 115 that closely aligns with the target attributes. The audio data 115 generated in these early iterations can serve as a starting point for iterative optimization of the parameters 112, which can be adjusted/optimized according to the techniques described herein to better match the target attributes over successive iterations.

In some implementations, the audio data 115 generated during each iteration of the parameter optimization process can be stored in a database or memory location associated with an identifier of the specific iteration. For example, the audio data 115 from the first iteration can be stored with an identifier such as “Iteration_001,” while the audio data 115 from the second iteration can be stored with an identifier such as “Iteration_002.” The identifier can be used to track/monitor progress of parameter 112 optimization and corresponding generation of samples of audio data 115 across different iterations. Storing audio data 115 with iteration identifiers can enable comparison of samples of audio data 115 between iterations for evaluation, in some implementations.

Once the sample of audio data 115 has been generated for the current iteration, the noise generator 116 can generate noise to be added to the generated audio data 115 to create a noised audio sample. The noise generator 116 can employ various techniques to generate noise, including but not limited to Gaussian noise, white noise, and pink noise. For example, Gaussian noise can be generated by sampling from a normal distribution with a specified mean and standard deviation. Generating the Gaussian noise can include calculating the mean and standard deviation of the noise distribution, and then generating random values that follow this distribution using a random number generation technique. The noise generator 116 can use these random values to create noise data that is added to the audio data 115.

In some implementations, the noise generator 116 can add the generated noise to the sample of audio data 115 by superimposing the noise signal onto the audio data. For example, the noise generator 116 can sum the amplitude values of the audio data 115 with the corresponding amplitude values of the noise data. The resulting noised audio sample can be a combination of the generated sample of audio data 115 and the added noise, which can be used as input to the generative machine-learning model 120. In some implementations, the noise generator 116 may format, encode, or otherwise modify the noised audio sample to conform to input requirements of the generative machine-learning model 120. This may include encoding or decoding the noised audio sample into a particular format, modifying the bitrate of the audio sample, or other format modifications. The noised audio sample generated by the noise generator 116 can be stored in association with the noise and the iteration identifier. For example, the noised audio sample from the first iteration and the corresponding noise data can be stored with an identifier such as “Iteration_001,” while the noised audio sample and the corresponding noise data from the second iteration can be stored with an identifier such as “Iteration_002.”

Once generated, the data processing system 102 can provide the noised audio sample as input to the generative machine-learning model 120. The generative machine-learning model 120 can include an audio diffusion model or any other type of machine-learning model that can predict noise to add to a sample of audio data. For example, the generative machine-learning model 120 can be a pre-trained audio diffusion model that is trained/updated to generate audio output based on the input text data 110. The audio diffusion model can operate by iteratively denoising an input sample, thereby refining the audio data to align with the target attributes specified in the input text data 110. To refine the input sample, the generative machine-learning model 120 can generate predicted noise in the sample, which can be subtracted at each iteration to refine the sample towards the attributes specified via the input text data 110.

The input text data 110 can specify the desired characteristics of the audio data 115, such as material properties, environmental conditions, or relative distance/locations of source sources (e.g., to simulate spatial audio), ensuring that the generated audio data 115 matches the intended attributes. The input text data 110 may be provided as a natural language prompt and may be stored in association with the set of parameters 112 being optimized according to the techniques described herein. In some implementations, the input text data 110 may be provided via operator input to the data processing system 102 or from an external computing system in communication with the data processing system 102. The input text data 110 for a given set of parameters 112 can be maintained as constant for each iteration of the optimization process for the set of parameters 112. Using the same input text data 110 for each iteration can ensure that the generative machine-learning model 120 can be used to generate gradients for the same attributes across all iterations.

Although the generative machine-learning model 120 is shown as external to the data processing system 102, it should be understood that in some implementations, the generative machine-learning model 120 may be internal to (e.g., a component of) the data processing system 102. In the example shown, the generative machine-learning model 120 may be maintained by one or more external computing systems. In an external configuration, the data processing system 102 may access functionality of the generative machine-learning model 120 by communicating one or more requests to the generative machine-learning model 120. The requests may include the noised audio sample, the input text data 110, and/or additional parameters to generate the predicted noise, including a number of denoising iterations to execute, among other configuration parameters for the generative machine-learning model 120. In an implementation where the generative machine-learning model 120 is stored and executed at the data processing system 102, the text input data 110 and the configuration parameters for the generative machine-learning model 120 can be stored in memory of the data processing system 102 and provided to the generative machine-learning model 120 as input.

The generative machine-learning model 120, upon receiving the noised audio sample, parameters, and text input data 110, can be executed to predict the noise content that was added to the audio data 115. As the generative machine-learning model 120 also predicts the noise such that the input sample (e.g., the noised audio sample) is refined toward the target attributes indicated in the input text data 110, the predicted noise generated by the generative machine-learning model 120 includes a prediction of both the added noise and a gradient indicating the direction and magnitude of adjustments suitable/appropriate/needed to align the noised audio data with the target attributes specified in the input text data 110.

To generate the predicted noise data for the noised audio data, the generative machine-learning model 120 can be executed for multiple iterations to predict noise and/or adjust the noised audio data to better match the target attributes specified via the input text data 110. For example, the generative machine-learning model 120 may include one or more transformer layers trained/updated to decode and recognize natural language, and automatically configure the audio diffusion model to predict noise that refines the input noised audio sample toward the target attributes. The generative machine-learning model 120 can calculate and/or sum predicted noise data across any number of iterations. The noise data predicted by the generative machine-learning model 120 can conform to (e.g., in size, dimensions, format, etc.) to the noise data generated by the noise generator 116, as described herein.

The predicted noise data can be received from the generative machine-learning model 120 and stored in memory of the data processing system 102 in association with the noised audio data 115. The predicted noise data generated using the generative machine-learning model 120 can be used to update/optimize the parameters 112 for a subsequent iteration of the score-distillation sampling process. To update/optimize the parameters 112, the data processing system 102 can execute the parameter updater 118. The parameter updater 118 can include software, hardware, or combinations thereof. To update the parameters 112, the parameter updater 118 can first calculate the difference between the noise added to the sample of audio data 115 and the predicted noise by subtracting the noise added to the sample of audio data 115 from the predicted noise generated by the generative machine-learning model 120. The resulting difference can provide a low variance update direction that can be used to update the parameters 112 using a suitable optimization process, such as gradient descent optimization.

The parameter updater 118 can determine a loss using the difference between the predicted noise and the noise. The loss can be a measure of the difference between audio that is generated using the generative machine-learning model 120 given the input text data 110 and the sample of audio data 115 generated using the current parameters 112. The parameter updater 118 can calculate a gradient using the loss that can be used to generate an updated set of parameters 112 using a VPJ, as provided in the example formula below:

$${θ}^{′} = {DR ( θ )}^{T} [ {ε}_{ϕ} ( x + ε ) - ε ]$$

In the above example equation, θ′ refers to the gradient that is to be used to generate the updated set of parameters 112, DR(θ)^{T} refers to the transpose of the Jacobian of the rendering function R (e.g., implemented by the audio renderer to generate the sample of audio data 115 for the current operation) where θ refers to the parameters 112 for the current iteration of the score-distillation sampling algorithm, x refers to the sample of audio data 115 generated by the audio renderer 114 for the current iteration, ε refers to the noise generated by the noise generator 116, and ε_{φ} refers to the noise prediction function implemented by the generative machine-learning model 120, which processes the input text data 110 (an explicit representation of which is omitted here for simplicity).

The parameter updater 118 can update the parameters 112 for a subsequent iteration of the score-distillation sampling process using a suitable optimization process. For example, the parameter updater 118 can implement a gradient descent optimization function or an Adam optimizer function, among others, to optimize the parameters according to the calculated gradient. In some implementations, the parameter updater 118 may calculate the gradient of the loss function using a backpropagation algorithm, for example, when the parameters 112 are parameters of a neural network-based renderer implemented by the audio renderer 114. The parameter updater 118 may implement the optimizer function according to any number of hyperparameters, including but not limited to learning rate or learning rate decay, among others, according to configuration settings of the data processing system 102. The configuration settings for the optimization process may be stored in memory of the data processing system 102, provided from one or more external computing systems, and/or provided via operator input to the data processing system 102.

Once the updated parameters 112 are generated using the optimization function, the data processing system 102 can use the updated parameters 112 for a subsequent iteration of the score-distillation sampling optimization process. The updated parameters 112 can be stored in association with an identifier of the iteration used to generate the parameters 112, in some implementations. This can enable the data processing system 102 to store/maintain multiple sets of parameters 112 to compare performance across multiple iterations of the score-distillation sampling process.

The data processing system 102 can iteratively repeat the score distillation sampling process until a termination condition has been satisfied. In some implementations, the termination condition may be satisfied once the parameters 112 have been updated for a predetermined number of iterations. The number of iterations may be a hyperparameter of the score distillation sampling process and may be stored in memory of the data processing system 102, provided from one or more external computing systems, and/or provided via operator input to the data processing system 102. In some implementations, the termination condition may be satisfied once the loss is less than a predetermined threshold (which may also be a hyper parameter of the score-distillation sampling process). Other termination conditions may also be implemented.

In some implementations, once the parameters 112 have been optimized/updated, the data processing system 102 can generate output audio 122 using the parameters and the rendering process implemented by the audio renderer 114. The output may be generated using the parameters and additional input information, for example, to generate audio according to the optimized/updated parameters 112 in different contexts. The data processing system 102 may provide (e.g., to an external computing system) the optimized/updated parameters 112, as well as any generated output audio 122, in response to a corresponding request to generate the parameters 112. In some implementations, the data processing system 102 can store the optimized/updated parameters 112 generated according to the techniques described herein in a storage repository and/or in the memory of the data processing system 102.

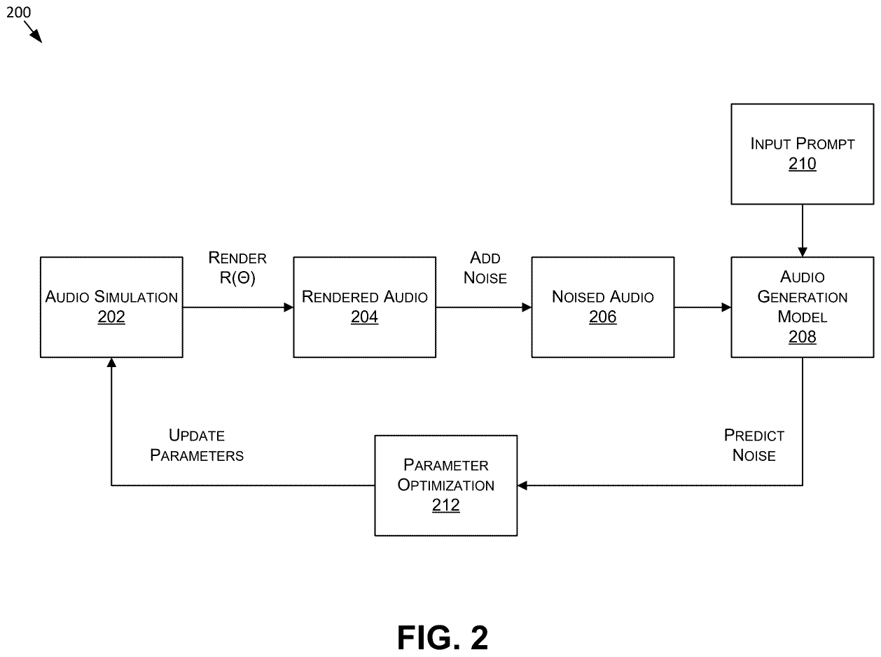

Referring to FIG. 2, depicted is an example data flow diagram 200 showing the iterative updating/optimization of parameters (e.g., parameters 112) for rendering audio according to the score-distillation sampling techniques described herein, in accordance with some embodiments of the present disclosure. As shown, the score-distillation sampling process can begin by executing an audio simulation 202 to generate rendered audio 204 according to a rendering function R(θ), where θ is the set of parameters to be optimized. Executing the audio simulation 202 can include performing any of the functionality described in connection with the audio renderer 114 of FIG. 1. The rendered audio 204 may be audio data 115 of FIG. 1 and may be provided in any suitable format.

Noise can then be added, for example, by performing any of the operations described in connection with the noise generator 116, to generate the noised audio 206. The noise added to the rendered audio 204 can be any suitable type of noise, including Gaussian noise. The noised audio 206 and the input prompt 210 can be provided as input to the audio generation model 208 (e.g., the generative machine-learning model 120). As described herein, the audio generation model 208 can include a pre-trained audio diffusion model, which can generate predicted noise given an input sample (e.g., the noised audio 206) and input text data (e.g., the input prompt 210). The input prompt 210 can guide the audio generation model 208 to generate noise that, when subtracted from the input sample, causes the resulting output to resemble attributes specified in the input prompt 210.

The predicted noise and the generated noise can be used in parameter optimization process, in which the generated noise is subtracted from the predicted noise to generate a gradient for the parameters used to generate the rendered audio 204. The parameter optimization process 212 can implement a suitable optimization/update function, such as a gradient descent optimization function or an Adam optimization function, among others. The updated parameters can then be used by the audio simulation 202 to generate rendered audio 204 for a subsequent iteration of the score-distillation sampling process. This approach can be repeated for any number of iterations until a termination condition has been satisfied.

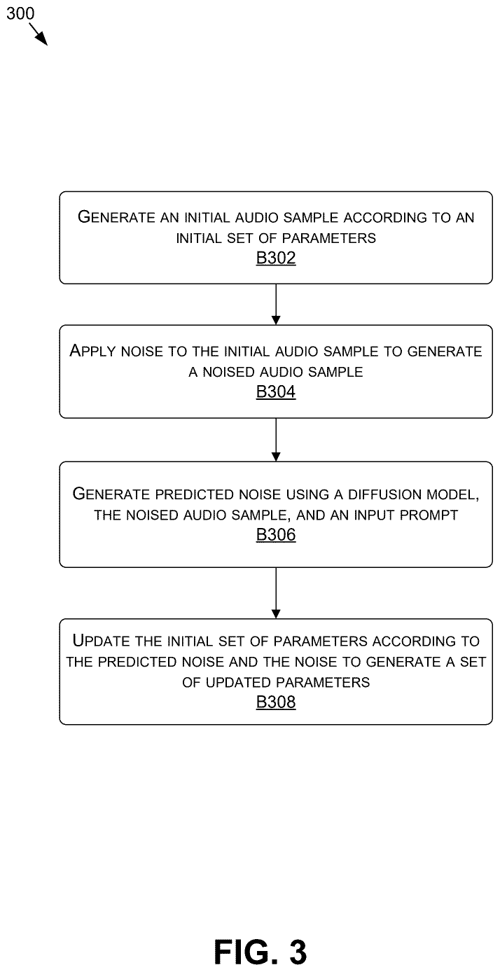

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for using score-distillation sampling to generate audio, in accordance with some embodiments of the present disclosure. The method 300, at block B302, includes generating an initial audio sample (e.g., audio data 115) according to an initial set of parameters (e.g., initialized parameters 112). The parameters may be initialized at the start of a score-distillation sampling process, where the parameters are set to default values or random values, in some implementations. The initial audio sample can be generated using any suitable audio rendering process that uses the parameters, including but not limited to a physical simulation, a spatial audio simulation, or any other differentiable sound rendering process.

The method 300, at block B304, includes applying noise to the initial audio sample to generate a noised audio sample. The noise can be generated according to any suitable technique, including sampling from a Gaussian distribution or another suitable distribution, in some implementations. In some implementations, the noise can be applied by summing the amplitude values of the audio sample generated at block B302 with the corresponding amplitude values of the noise data. The noised audio sample and the noise added to the audio sample can be stored in association with an identifier of the iteration of the score-distillation sampling process.

The method 300, at block B306, includes generating predicted noise using an audio diffusion model (e.g., the generative machine-learning model 120), the noised audio sample, and/or an input prompt (e.g., the input text data 110). The predicted noise can be an output of the audio diffusion model. As described herein, the input prompt can guide the audio diffusion model to predict noise to subtract from the noised audio sample to result in an output audio sample that aligns with attributes of specified in the input prompt. The input prompt may include a natural language prompt. For example, the audio diffusion model may include one or more transformer layers that can process and/or understand target attributes or other target characteristics of the audio that is to be generated via the audio diffusion model.

In one example, the input prompt can identify a material property of the output sound (e.g., a “metallic” sound). In another example, the input prompt can identify a location of a sound source relative to the listener, to optimize/update the parameters to effectively simulate/produce spatial audio. Other input prompts are also possible. The audio diffusion model can be a model that is pre-trained/updated on large corpuses of text and corresponding audio data. The audio diffusion model can be trained/updated to be generalized, such that the audio diffusion model can generate any type of output audio specified via the input prompt (and corresponding predicted noise).

The method 300, at block B308, includes updating the initial set of parameters according to the predicted noise and/or the noise to generate a set of updated parameters. The noise can be subtracted from the predicted noise to generate a loss, which can be used to generate a gradient for the parameters with respect to the audio rendering function used to generate the audio sample in block B304. Updating the parameters may include performing a gradient descent optimization function, an Adam optimization function, or any other suitable optimization function. Optimizing the parameters can include performing any of the functionality described herein in connection with the parameter updater 118. The parameters can be iteratively updated until a termination condition (e.g., a predetermined number of conditions, loss falling below a threshold, etc.) has been satisfied, as described herein.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-516(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may use distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
generate an initial audio sample according to an initial set of parameters;
apply noise to the initial audio sample to generate a noised audio sample;
generate predicted noise using a diffusion model, the noised audio sample, and an input prompt; and
update the initial set of parameters according to the predicted noise and the noise to generate a set of updated parameters.

2. The one or more processors of claim 1, wherein the input prompt identifies at least one material property, and wherein the one or more circuits are to:
generate the initial audio sample using a physical simulation according to the initial set of parameters.

3. The one or more processors of claim 1, wherein the input prompt identifies a relative location of a sound source, wherein the one or more circuits are to:
simulate spatial audio according to the initial set of parameters to generate the initial audio sample.

4. The one or more processors of claim 1, wherein the one or more circuits are to:
update the initial set of parameters based at least on a vector Jacobian product (VJP).

5. The one or more processors of claim 1, wherein the one or more circuits are to:
update the initial set of parameters according to a gradient descent function.

6. The one or more processors of claim 5, wherein the one or more circuits are to:
determine a loss based at least on the predicted noise and the noise; and
update the initial set of parameters to minimize the loss using the gradient descent function.

7. The one or more processors of claim 1, wherein the one or more circuits are to:
iteratively update the updated set of parameters until a termination criterion is satisfied.

8. The one or more processors of claim 7, wherein the termination criterion comprises a predetermined number of iterations.

9. The one or more processors of claim 1, wherein the one or more circuits are to:
generate the noise according to a Gaussian distribution.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

11. A system, comprising:
one or more processors to:
iteratively update a set of parameters by rendering an audio sample using the set of parameters, applying noise to the audio sample, and applying gradient descent optimization to the set of parameters according to an output of an audio diffusion model and the noised audio sample;
determine that a termination criterion for updating the set of parameters has been satisfied; and
responsive to determining that the termination criterion is met, provide an output audio sample generated using the updated set of parameters.

12. The system of claim 11, wherein the one or more processors are to:
generate the output of the audio diffusion model further based on an input text prompt specifying a target attribute of the audio sample.

13. The system of claim 11, wherein the one or more processors are to:
calculate a gradient for updating the parameters using the output of the audio diffusion model and the noise applied to the audio sample.

14. The system of claim 11, wherein the one or more processors are to:
initialize the set of parameters to random values.

15. The system of claim 11, wherein the one or more processors are to:
optimize a plurality of sets of parameters to generate a plurality of audio samples, at least one audio sample corresponding to one or more respective target attributes.

16. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a multi-modal language model;
a system for performing generative AI operations using a large language model (LLM);
a system for performing generative AI operations using a video language model (VLM);
a system for generating synthetic data;
a system incorporating one or more virtual machines (VMs);
a system using or deploying one or more inference microservices;
a system that incorporates one or more machine learning models deployed in a service or microservice along with an OS-level virtualization package (e.g., a container);
a system implemented at least partially in a data center; or
a system implemented at least partially using cloud computing resources.

17. A method, comprising:
generating, using one or more processors, an initial audio sample according to an initial set of parameters;
applying, using the one or more processors, noise to the initial audio sample to generate a noised audio sample;
generating, using the one or more processors, predicted noise using a diffusion model, the noised audio sample, and an input prompt;
updating, using the one or more processors, the initial set of parameters according to the predicted noise and the noise to generate a set of updated parameters;
generating, using the one or more processors, an output audio sample according to the set of updated parameters; and
storing, using the one or more processors, the output audio sample in a dataset of audio samples.

18. The method of claim 17, wherein the input prompt identifies at least one material property, and further comprising:
generating, using one or more processors, the initial audio sample using a physical simulation according to the initial set of parameters.

19. The method of claim 17, wherein the input prompt identifies a relative location of a sound source, and further comprising:
simulating, using one or more processors, spatial audio according to the initial set of parameters to generate the initial audio sample.

20. The method of claim 17, further comprising:
updating, using one or more processors, the initial set of parameters based at least on a vector Jacobian product (VJP).
